(19) United States
(12) Patent Application Publication
(10) Pub. No.: US 2011/0194550 A1
(43) Pub. Date: Aug. 11, 2011

(54) HOME BASE STATION AND METHOD FOR CONTROLLING THE SAME

(75) Inventors: Jaihyung Cho, Daejeon (KR); Sang-Ho Lee, Daejeon (KR)

(73) Assignee: ELECTRONICS AND TELECOMMUNICATIONS RESEARCH INSTITUTE, Daejeon (KR)

(21) Appl. No.: 13/123,020

(22) PCT Filed: Oct. 13, 2009
(86) PCT No.: PCT/KR09/05879

§ 371 Date: Apr. 7, 2011

(30) Foreign Application Priority Data
Oct. 14, 2008 (KR) 10-2008-0100817
Dec. 22, 2008 (KR) 10-2008-0131046

(51) Int. Cl. H04W 4/00

(52) U.S. Cl. 370/338

(57) ABSTRACT

A home base station includes a packet process unit configured to process a received data from mobile network to transmit the processed data to a mobile terminal; and an image processor configured to process the received data from the packet process unit by mixing with a received image data from exterior to transmit the mixed data to an image processing apparatus being connected with the home base station. A method for controlling the home base station includes a receiving data from a mobile terminal; and transmitting the received data to a mobile network by mixing with a received image data from a image process unit being connected with the home base station.

### TECHNICAL FIELD

The present invention relates to a home base station and a method for controlling the home base station; and, more particularly, to a home base station and a method for providing a received data from a mobile terminal to an image processor by using the home base station.

### BACKGROUND ART

In general, a home base station is used to improve the capacity and coverage of a mobile communication service in a basement of building or indoor. The home base station is also called femtocell and is connected to an Internet cable, such as ADSL and DSL at home. When a mobile station is within the cell coverage of the home base station, the mobile station is connected not to a local base station but to the home base station. In other word, the mobile station is connected to a mobile communication network through the home base station for servicing a mobile data communication. On the contrary, when the mobile station is out of the cell coverage of the home base station, the mobile station is connected to the nearest local base station for servicing a mobile communication.

Meanwhile, the home network system is a technology for networking home appliances at home by vesting the home appliances with data communication function. The home network system has been evolved according to spreading Internet service at home accompanied a development of high-speed wireless communication technology and broadcasting technology.

The mobile station transmits data to a sever of the home network system and the transmitted data is displayed on an image processor, e.g., TV or PC, connected with the home network system in the home network system. However, the data is limited to text data and the home network system is improper for adjusting in the home network system in conventional invention.

### DISCLOSURE OF INVENTION

### Technical Problem

An embodiment of the present invention is directed to providing a home base station for providing a received data from a mobile terminal to an image processing unit.

Another embodiment of the present invention is directed to providing a method for providing a received data from a mobile terminal to an image processing unit.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Solution to Problem

In accordance with an aspect of the present invention, there is provided a home base station, which includes a packet process unit configured to process a data received from a mobile network and to transmit the processed data to a mobile terminal; and an image processor configured to mix the processed data from the packet process unit with a image data received from exterior and to transmit the mixed data to an image processing device connected to the home base station.

In accordance with another aspect of the present invention, there is provided a home base station, which includes an image processor configured to convert a received image signal from an image processing device connected to the home base station to an image data; and a packet process unit configured to mix the image data with a data received from mobile terminal and to transmit the mixed data to a mobile network.

In accordance with another aspect of the present invention, there is provided a method for controlling a home base station, which includes receiving data from a mobile terminal; and transmitting a mixed data to a mobile communication network by mixing the received data with a received image data from an image process device connected with the home base station.

### Advantageous Effects of Invention

The present invention relates to a home base station for providing a received data from a mobile terminal to an image processing unit. The present invention relates to a method for controlling the home base station, which provides a received data from a mobile terminal to an image processing unit.

### BRIEF DESCRIPTION OF DRAWINGS

FIG. 1 is a schematic diagram of a home base station network including a home base station in accordance with an embodiment of the present invention.

FIG. 2 is a flowchart describing a method for processing a received data from a mobile terminal by using a home base station in accordance with an embodiment of the present invention.

FIG. 3 is a flowchart describing a method for transmitting data to a mobile communication network using a home base station in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter.

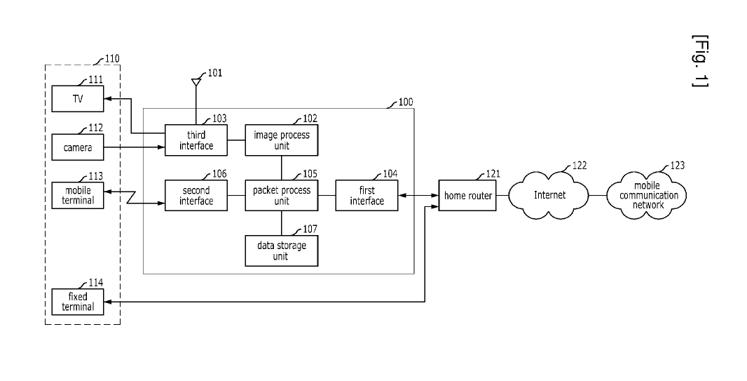

FIG. 1 is a schematic diagram of a home base station network including a home base station accordance with an embodiment of the present invention.

Referring to FIG. 1, the home base station network includes a home base station 100, a plurality of image process devices 110, a mobile terminal 113, a home router 121, Internet 122 and a mobile communication network 123.

The plurality of image process devices 110 include all devices which can receive data from an exterior through wireless or wire communication network to process the received data and can display the processed data. In the description on each embodiment of present application, the data includes text data, image data, video data and audio data. Also, the plurality of image process devices 110 include all devices which can generate the data as well as displaying the data. In the description on each embodiment of the present invention, a TV 111, a camera 112 and a fixed terminal 114 will be described as examples of the image process devices 110. The mobile terminal 113 displaying the data may be an example of the image process devices 110. However, the spirit and scope of the present invention are not limited to the examples.

Hereinafter, the image process devices 110 will be described in detail with reference to the accompanying drawings. The TV 111 displays a received data from the home base station 100 on a screen of the TV 111. The camera 112 generates data. The generated data is transmitted to the mobile terminal 113 through the home base station 100 in response to a request of a user. The fixed terminal 114 (e.g., a PC) displays a received data from the mobile terminal 113 through the home router 121 on a display unit (e.g., a PC monitor) of the fixed terminal 114.

The mobile terminal 113 transmits and receives data like as text (e.g., a short message service (SMS) and e-mail), audio data (e.g., voice data, music) and image data (e.g., picture, video). The mobile terminal 113 is connected to the mobile communication network 123 through the home base station 100 when the mobile terminal 113 is within the cell of the home base station 100. The mobile terminal 113 is connected to the mobile communication network 123 through the nearest local repeater (not shown) when the mobile terminal 113 is out of the cell of the home base station 100.

The home router 121 networks the fixed terminal 114 to the home base station 100. Although the home router 121 is in exterior of the home base station 100 in FIG. 1, the home router 121 may be within the home base station 100.

Hereinafter, the home base station 100 will be described in detail with reference to the accompanying drawings.

The home base station 100 includes an antenna 101, an image process unit 102, a third interface 103, a first interface 104, a packet process unit 105, a second interface 106 and data storage unit 107.

The antenna 101 receives a TV broadcasting signal from a broadcasting station (not shown). In the description on each embodiment, the TV broadcasting signal includes a signal of Internet Protocol Television (IPTV) being delivered through the Internet 122 as well as a traditional radio frequency broadcast and cable television (CATV) formats.

The image process unit 102 demodulates a provided TV broadcasting signal from the antenna 101 to generate broadcasting data and provides the broadcasting data to the TV 111 through the third interface 103, wherein the third interface 103 may be a video in/out interface. Also, the image process unit 102 mixes streaming data from the packet process unit 105 with the TV broadcasting data to generate a data. The image process unit 102 provides the data to the TV 111 when the mobile terminal 113 is within a cell of the home base station 100. Also, the image process unit 102 processes the data from the camera 112 to provide the processed data to the packet process unit 105.

The third interface 103 connects the image process unit 102 and the TV 111, or the image process unit 102 and the camera 112. Also, the third interface 103 provides the processed data by the image process unit 102 to the TV 111 or the camera 112.

The first interface 104 connects the home base station 100 and the mobile communication network, wherein the first interface 104 may be a wired in/out interface.

The packet process unit 105 receives data to be provided to the mobile terminal 113 from the mobile communication network 132 when the mobile terminal 113 is within a cell of the home base station 100. The packet process unit 105 processes the received data to provide the processed data to the mobile terminal 113. Also, the packet process unit 105 mixes the received data from the mobile terminal 113 with data from the image process unit 102 with provide the mobile communication network 123 to the mixed data when the mobile terminal 113 is within the cell of the home base station 100. Also, the packet process unit 105 converts data from the mobile terminal 113 to streaming data to provide the image process unit 102 with it.

The second interface 106 connects the mobile terminal 113 and the packet process unit 105. Herein, the second interface 106 may be a wireless interface.

The data storage unit 107 temporarily stores the data from the packet process unit 105 in response to controlling of the packet process unit 105.

Data between the home base station 100 and the mobile communication network 123 includes a received and transmitted data (e.g., audio data, text data and video data) through the Internet 122 and the mobile communication network 123 and data to be communicated with a digital home appliances (eg., TV or PC).

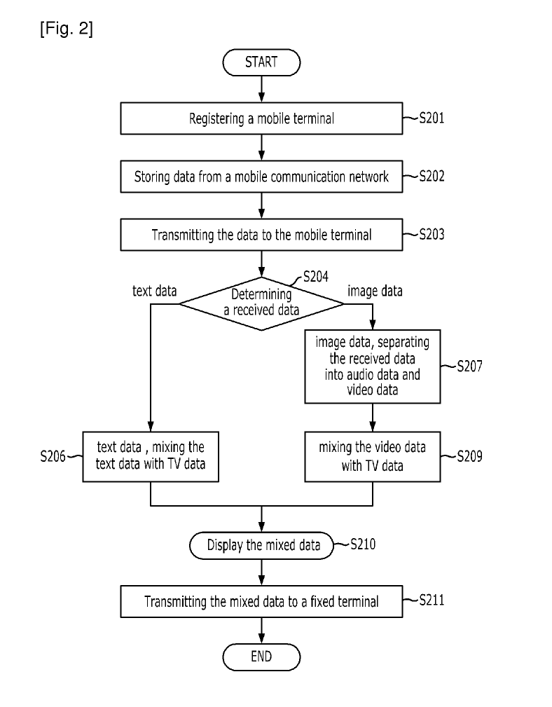

Hereinafter, a method for processing a received data from a mobile terminal by the home base station FIG. 1 will be described in detail with reference to a FIG. 2.

FIG. 2 is a flowchart describing a method for processing a received data from a mobile terminal by a home base station accordance with an embodiment of the present invention.

Referring to step S201 of FIG. 2, the home base station 100 registers a mobile terminal 113 on a mobile communication network 123 to inform the mobile communication network 123 that the mobile terminal 113 is within a cell of the home base station 100 when the mobile terminal 113 enters the cell of the home base station 100. Through the step S201, the mobile terminal 113 is disconnected from a local base station to which it has been or another home base station previously connected and newly connected to the home base station 100 thereby to receive data from the mobile communication network 123 through the home base station 100 when the mobile terminal 113 is within the cell of the home base station 100. That is, all of data received by the mobile terminal 113 from the mobile are transmitted through the home base station 100 when the mobile terminal 113 is within the cell of the home base station 100.

After the step S201, when the mobile terminal 113 receives text data, audio data or image data, the received data are provided to the packet process unit 105 through a first interface 104 of the home base station 100. Herein the first interface 104 is a wired in/out port for interfacing a packet process unit 105 and a home router 121.

In step S202, the packet process unit 105 processes the provided data and stores the processed data in the data storage unit 107. In step S203, the packet process unit 105 transmits the processed data to the mobile terminal 113. In step S204, the home base station 100 determines that the data is the text data or the image data. Herein, the image data includes audio data and video data. When the received data is text data, the packet process unit 105 provides the text data to the image process unit 102. In steps S206 and S210, the image process unit 102 mixes the provided text data with TV broadcasting data to display it on screen of a TV 111. When the received data is the image data, the packet process unit 105 separates the image data into audio data and video data in step S207. The packet process unit 105 provides the image to the image process unit 102. The image process unit 102 mixes the image data with the TV broadcasting data to display it on screen of the TV 111 in step S210.

When the fixed terminal 114 is connected with the home base station 100 through the home router 121, the packet process unit 105 transmits the mixed data in the data storage unit 107 to the fixed terminal 114 in step S211. That is, when the fixed terminal 114 is connected with the home base station 100 through the home router 121, the fixed terminal 114 may display the text data or the image data transmitted from the mobile terminal 113.

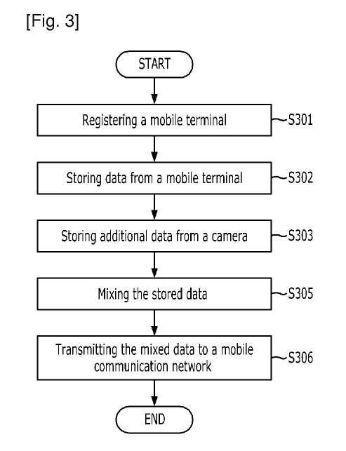

FIG. 3 is a flow chart describing a method for transmitting data to a mobile communication network by using a home base station in accordance with an embodiment of the present invention.

Referring to in step S301 of FIG. 3, a home base station 100 registers a mobile terminal 113 on a mobile communication network 123 to inform the mobile communication network that the mobile terminal 113 is within the cell of the home base station 100 when the mobile terminal 113 enters a cell of the home base station 100. In step S302, the home base station 100 stores a received data from the mobile terminal 113 in the data storage unit 107 to transmit the received data to other mobile terminal. Then, the home base station 100 transmits the stored data to the mobile communication network 123 through an Internet 122. When a user requests to transmit the stored data to the mobile communication network 123 with additional data received from image process device 100, the packet process unit 105 provides the additional data to the data storage unit 107. For example, a user requests to transmit audio data through the mobile terminal 113 and to transmit video data through a camera 112 being connected to the home base station 100, the video data is stored in the data storage unit 107 by controlling the packet process unit 105 in step S303. In steps S305 and S306, the packet process unit 105 mixes the audio data with the video data and transmits the mixed data to the mobile communication network 123.

In the step S303, the home base station 100 may mix data from the fixed terminal 114, e.g., home appliance with the audio data from the mobile terminal 113 to transmit the mixed data to the mobile communication network 123.

Meanwhile, the method of the present invention described above may be programmed for a computer. The computer program may be stored in a computer-readable recording medium, i.e., data storage, and it may be read and executed by a computer to realize the method of the present invention. The recording medium includes all types of computer-readable recording media, that is, it includes not only tangible media such as CD and DVD, but also intangible media such as carrier wave.

The present application contains a subject matter related to Korean Patent Applications No. 10-2008-0100817 and 10-2008-0131046, filed in the Korean Intellectual Property Office on Oct. 14, 2008 and Dec. 22, 2008, the entire contents of which are incorporated herein by references.

While the present invention has been described with respect to the specific embodiments, it will be apparent to those skilled in the art that various changes and modifications may be made without departing from the spirit and scope of the invention as defined in the following claims.

1. A home base station, comprising:
a packet process unit configured to process a data received from a mobile network and to transmit the processed data to a mobile terminal; and
an image processor configured to mix the processed data from the packet process unit with a image data received from exterior and to transmit the mixed data to an image processing device connected to the home base station.

2. The home base station of claim 1, wherein the image processor converts a received broadcasting signal to a first image data to display the first image data on a display unit of the image processing device, converts the received data from the packet process unit to a second image data to display the second image data on the display unit of the image processing device, and mixes the first image data with the second image data to transmit the mixed data to the image processing device.

3. The home base station of claim 1, further comprising:
a data storage unit configured to store the received data from packet process unit and the received image data from exterior.

4. The home base station of claim 1, further comprising:
a home router configured to connect the home base station to the image processing device.

5. The home base station of claim 1, wherein the received data from mobile network includes text data, audio data and video data.

6. The home base station of claim 1, wherein the image data is an image included in a received broadcasting signal.

7. A home base station, comprising:
an image processor configured to convert a received image signal from an image processing device connected to the home base station to an image data; and
a packet process unit configured to mix the image data with a data received from mobile terminal and to transmit the mixed data to a mobile network.

8. The home base station of claim 7, wherein the received data from mobile terminal includes an audio data.

9. A method for controlling a home base station, comprising:
receiving data from a mobile communication network; and
transmitting a mixed data to an image processing devices being connected with the home base station by mixing the received data with a received image data from exterior.

10. The method of claim 9, wherein the image data is a broadcasting data of a received broadcasting signal.

11. The method of claim 9, wherein the received data includes text data and an image data.

12. A method for controlling a home base station, comprising:
receiving data from a mobile terminal; and
transmitting a mixed data to a mobile communication network by mixing the received data with a received image data from a image process device connected with the home base station.

13. The method of claim 12, wherein the received data includes an audio data.
